(19) United States
(12) Patent Application Publication
(10) Pub. No.: US 2020/0281804 A1
(43) Pub. Date: Sep. 10, 2020

(54) Massage Insole Driven by Intelligent Sensing motor

(71) Applicant: King Tong Thomas YAN, Hong Kong (HK)

(72) Inventor: King Tong Thomas YAN, Hong Kong (HK)

(21) Appl. No.: 16/384,941

(22) Filed: Apr. 16, 2019

(30) Foreign Application Priority Data
Mar. 4, 2019 (CN) 201910158275.0

(51) Int. Cl. A61H 11/00; A61H 15/00; A61H 39/00; A43B 17/00; A43B 7/14

(52) U.S. Cl. CPC A61H 11/00; A61H 2201/1207; A61H 39/00; A43B 17/00; A43B 7/146; A43B 7/149; A43B 7/144; A43B 7/145; A61H 2201/164; A61H 2201/165; A61H 2201/5007; A61H 2201/1654; A61H 2201/5082; A61H 2201/0207; A61H 2201/0228; A61H 15/0078

(57) ABSTRACT

The invention relates to a massage insole driven by intelligent sensing motor which includes a structurally symmetrical left insole and right insole. The left insole and the right insole each includes a massaging mechanism for massaging the sole of the foot, and a receiving pad body for receiving the massaging mechanism and a control mechanism. The control mechanism is arranged in the receiving pad body. The massaging mechanism includes a massage bead chain, a driving component for driving the massage bead chain to rotate, a reset component for driving the massage bead chain to be reset. Two ends of massage bead chain are respectively sleeved on the driving component and the reset component. The control mechanism includes a control chip, a timing component and a thermostatic component. The driving component, the timing component and the thermostat component are electrically connected to the control chip. For the massage insole driven by intelligent sensing motor, the massage beads can move, and avoids the soreness that exceeds the tolerance to emerge due to the foot stepping on the massage for a long time Feet can relax without taking off the shoes. It improves the use of massage insoles.

### FIELD OF THE INVENTION

The invention relates to o the field of physical therapy equipment, and in particular to a massage insole driven by intelligent sensing motor.

### BACKGROUND

Massage insole is designed for the acupuncture points and reflex zones of the foot, and the foot massage can be performed at all times. The massage insole improves myocardial function, promotes blood circulation, and enhances heart power. The massage insole adjusts the function of the viscera and enhances immunity. The massage insole can effectively promote the blood circulation of the soles of the feet, relieve fatigue, and perform magnetic massage at the same time, making your busy day easy and refreshing. Massage insole can moisturize and nourish, eliminate toxins, strengthen metabolism and maintain youthful vitality. The massage insole cleans the intestinal waste, the wide intestine and the stomach, and clears the human energy circulation pipeline. The massage insole has a long service life (available for 3-5 years) and is cost effective.

For the existing massage insole, the position of the massage beads is fixed, and the foot will be sore on the massage beads for a long time. At this time, the shoes need to be taken off to make the feet relax, and in some special occasions, it is not suitable for taking off the shoes, only being able to tolerate which will increase the annoyance of using the massage insole.

### SUMMARY OF THE INVENTION

The technical problem to be solved is to overcome the above-mentioned deficiency by providing a massage insole driven by intelligent sensing motor.

To solve the above problem, the present invention provides the following technical solution.

A massage insole driven by intelligent sensing motor includes a structurally symmetrical left insole and right insole. The left insole and the right insole each includes a massaging mechanism for massaging the sole of the foot, and a receiving pad body for receiving the massaging mechanism and a control mechanism. The control mechanism is arranged in the receiving pad body. The massaging mechanism includes a massage bead chain, a driving component for driving the massage bead chain to rotate, a reset component for driving the massage bead chain to be reset. Two ends of massage bead chain are respectively sleeved on the driving component and the reset component. The control mechanism includes a control chip, a timing component and a thermostatic component. The driving component, the timing component and the thermostat component are electrically connected to the control chip.

Further, the receiving pad body includes a main pad body for receiving the massaging mechanism, a first pad body for supporting the massage bead chain, and a second pad body disposed on the massage bead chain. The main pad body includes a receiving groove for receiving a massaging mechanism. The first pad body is disposed in the receiving groove. The bottom of the first pad body is provided with a toe hard plate near the toe.

Further, the reset component is disposed at an end of the first pad body near the toe. The reset component includes a reset socket spring, and the massage bead chain is sleeved on the socket spring and fixedly connected with the socket spring. The socket spring is fixedly connected to the hard plate by a connecting column. The first pad body is provided with a retreat groove for avoiding the rotation of the socket spring.

Further, the driving component includes a driving motor and a driving wheel. The driving wheel is fixedly mounted on an output end of the driving motor, and the driving motor is disposed at an end of the first pad body near the heel. The first pad body is provided with a through hole through which the driving motor passes. The drive wheel is provided with a groove for the massage bead chain to sleeve. The main pad body is provided with a pad heel for accommodating the driving motor at a position close to the heel.

Further, the massage bead chain is provided with a connecting rope body and a plurality of massage beads. All the massage beads are equally spaced on the connecting rope body. The first pad body is provided with a plurality of deep grooves arranged in a matrix and a number of shallow grooves distributed in a matrix. All deep grooves and all shallow grooves are arranged from the reset component to the driving component. All deep grooves and all shallow grooves are staggered one by one. All deep grooves and all shallow grooves correspond to all massage beads.

Further, the timing component includes a time relay, and the time relay is electrically connected to the control chip.

Further, the thermostat component includes a temperature sensor, a battery, and an electric heating wire embedded in the main pad body. The temperature sensor and the battery are electrically connected to the control chip, and the electric heating wire is electrically connected to the battery.

Further, the second pad body includes a plurality of escape holes for escaping all the massage beads, and all of the escape holes correspond to all massage beads.

The present invention provides the following technical effect by providing the massage insole driven by the intelligent sensing motor. When the foot is stepped on the massage insole, the time relay starts to count to a certain period of time, and sends an electrical signal to the control chip. The control chip controls the driving motor to rotate to drive the rotation of the massage bead chain. All the massage beads move to the corresponding shallow groove and the escape hole of the second pad body to interfere with the sole of the foot. After the time relay starts to count for a certain period of time, the control chip controls the driving motor to reverse. The socket spring fits and drives all the massage beads back into the corresponding deep grooves. All the massage beads are hidden under the second pad body, ensuring that the massage beads no longer massage the foot. The massage beads can move, and avoids the soreness that exceeds the tolerance to emerge due to the foot stepping on the massage for a long time Feet can relax without taking off the shoes. It improves the use of massage insoles.

### BRIEF DESCRIPTION OF THE DRAWINGS

The invention is illustrated by the following figures and embodiments.

FIG. 1 shows a schematic diagram of 3D structure of a massage insole driven by intelligent sensing motor in accordance with an example embodiment.

FIG. 2 shows a schematic diagram of decomposition structure of left insole of a massage insole driven by intelligent sensing motor in accordance with an example embodiment.

FIG. 3 shows a schematic diagram of another decomposition structure of left insole of a massage insole driven by intelligent sensing motor in accordance with an example embodiment.

FIG. 4 shows a schematic diagram of decomposition structure of second pad body, pad heel, and massage bead chain of a massage insole driven by intelligent sensing motor in accordance with an example embodiment.

FIG. 5 shows a schematic diagram of another decomposition structure of second pad body, pad heel, and massage bead chain of a massage insole driven by intelligent sensing motor in accordance with an example embodiment.

The reference numbers of the figures are as follows:

1: left insole; 2: right insole; 3: massaging mechanism; 3a: massage bead chain; 3a1: massage bead; 3a2: connecting rope body; 3b: reset component; 3b1: reset socket spring; 3b2: connecting column; 3c: driving component; 3c1: driving motor; 3c2: driving wheel; 4: receiving pad body; 4a: main pad body; 4b: first pad body; 4b1: shallow groove; 4b2: deep groove; 4b3: retreat groove; 4c: second pad body; 4c1: escape hole; 4d: pad heel; 5: toe hard plate.

### DETAILED DESCRIPTION

The invention is illustrated in accordance with figures. The figures as simplified diagrams demonstrate the basic structures of the apparatus of embodiments of the invention. Thus, the invention is not limited to the figures.

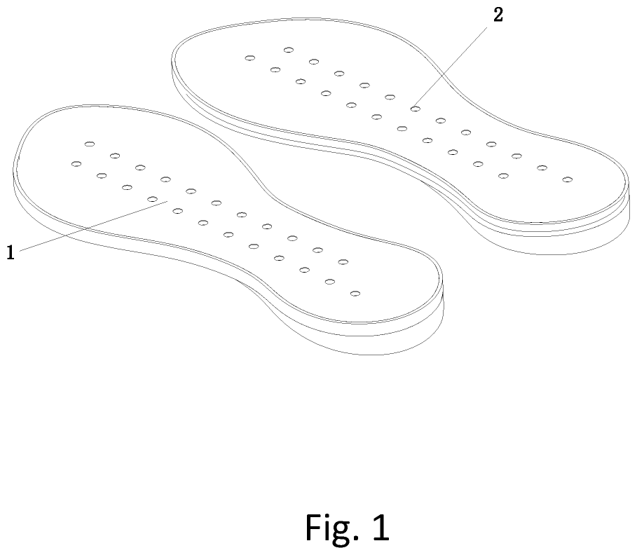

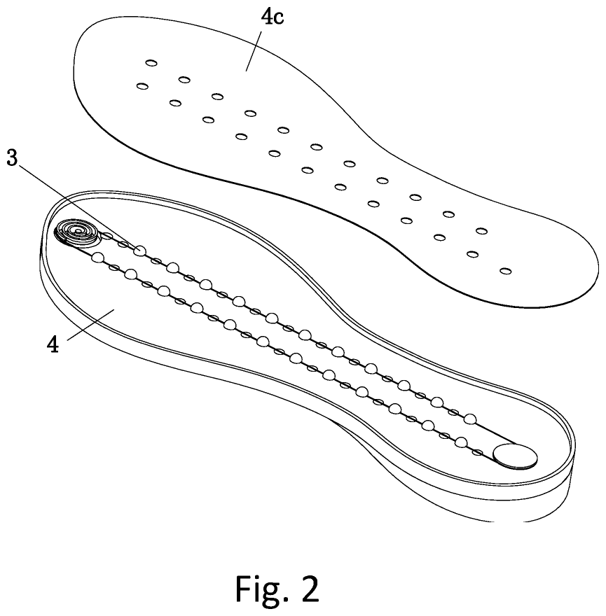

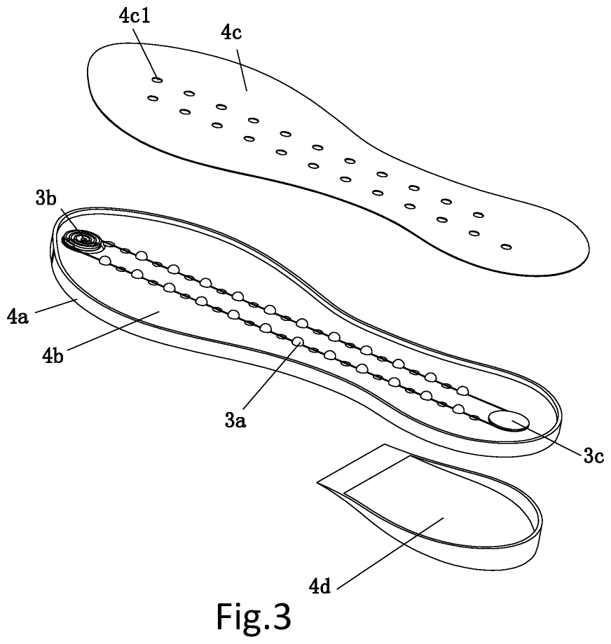

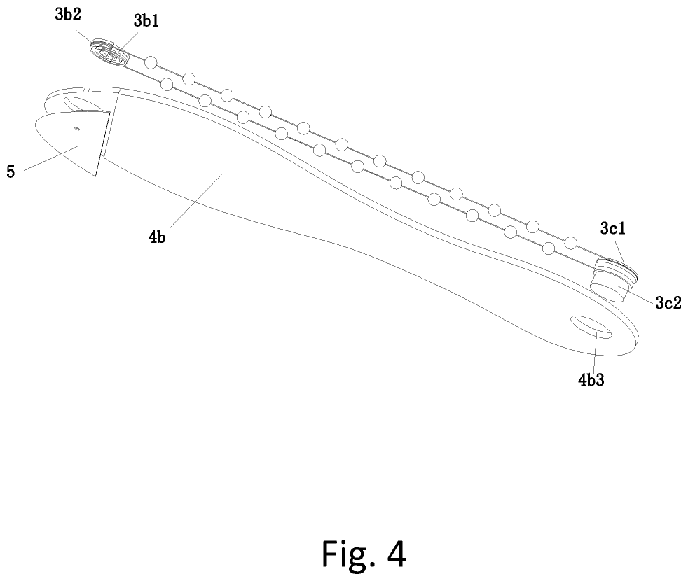

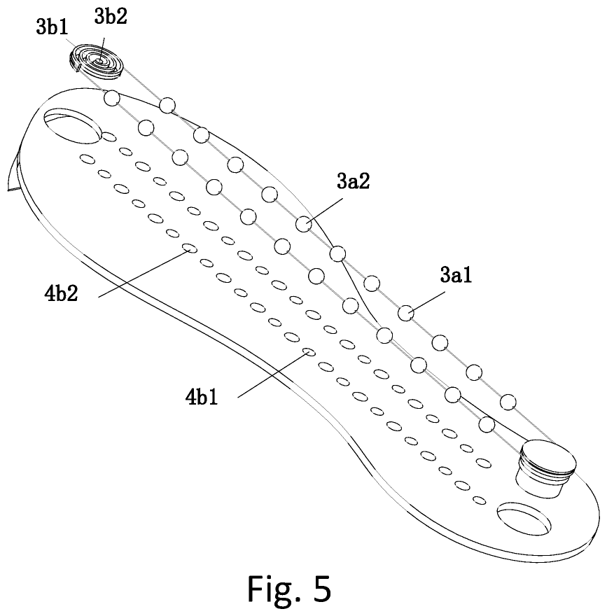

Referring to FIGS. 1-5, a massage insole driven by intelligent sensing motor includes a structurally symmetrical left insole 1 and right insole 2. The left insole 1 and the right insole 2 each includes a massaging mechanism 3 for massaging the sole of the foot, and a receiving pad body 4 for receiving the massaging mechanism and a control mechanism. The control mechanism is arranged in the receiving pad body 4. The massaging mechanism 3 includes a massage bead chain 3a, a driving component 3c for driving the massage bead chain 3a to rotate, a reset component 3b for driving the massage bead chain 3a to be reset. Two ends of massage bead chain 3a are respectively sleeved on the driving component 3c and the reset component 3b. The control mechanism includes a control chip, a timing component and a thermostatic component. The driving component 3c, the timing component and the thermostat component are electrically connected to the control chip. The driving component 3c and the reset component 3b cooperate to rotate the massage bead chain 3a back and forth, and the timing component and the control chip cooperate to rotate the massage bead chain 3a periodically.

The receiving pad body 4 includes a main pad body 4a for receiving the massaging mechanism 3, a first pad body 4b for supporting the massage bead chain 3a, and a second pad body 4c disposed on the massage bead chain 3a. The main pad body 4a includes a receiving groove for receiving a massaging mechanism 3. The first pad body 4b is disposed in the receiving groove. The bottom of the first pad body 4b is provided with a toe hard plate 5 near the toe. The first pad body 4b, the second pad body 4c and the main pad body 4a are made of soft gel material.

The reset component 3b is disposed at an end of the first pad body 4b near the toe. The reset component 3b includes a reset socket spring 3b1, and the massage bead chain 3a is sleeved on the socket spring and fixedly connected with the socket spring. The socket spring is fixedly connected to the hard plate by a connecting column 3b2. The first pad body 4b is provided with a retreat groove 4b3 for avoiding the rotation of the socket spring. When the massage bead chain 3a is in the unmassed state, the reset socket spring 3b1 is in a relaxed state, and when the drive component 3c drives the massage bead chain 3a to rotate, the return spring is in a tightened state.

The driving component 3c includes a driving motor 3c1 and a driving wheel 3c2. The driving wheel 3c2 is fixedly mounted on an output end of the driving motor 3c1, and the driving motor 3c1 is disposed at an end of the first pad body 4b near the heel. The first pad body 4b is provided with a through hole through which the driving motor 3c1 passes. The drive wheel 3c2 is provided with a groove for the massage bead chain 3a to sleeve. The main pad body 4a is provided with a pad heel 4d for accommodating the driving motor 3c1 at a position close to the heel. The driving motor 3c1 drives the bead chain 3a1 of massage bead chain to rotate by the drive wheel 3c2.

The massage bead chain 3a is provided with a connecting rope body 3a2 and a plurality of massage beads 3a1. All the massage beads 3a1 are equally spaced on the connecting rope body 3a2. The first pad body 4b is provided with a plurality of deep grooves 4b2 arranged in a matrix and a number of shallow grooves 4b1 distributed in a matrix. All deep grooves 4b2 and all shallow grooves 4b1 are arranged from the reset component 3b to the driving component 3c. All deep grooves 4b2 and all shallow grooves 4b1 are staggered one by one. All deep grooves 4b2 and all shallow grooves 4b1 correspond to all massage beads 3a1. The massage bead chain 3a is rotated to the massage state, and all the massage beads 3a1 are moved to the corresponding shallow groove 4b1 and the escape hole 4c1 of the second pad body 4c to be in contact with the sole of the foot. The massage bead chain 3a is rotated to the unmassed state, and the control chip controls the drive motor 3c1 to revert and the socket spring cooperates to drive all the massage beads 3a1 back into the corresponding deep groove 4b2, and all the massage beads 3a1 are hidden under the second pad body 4c.

The timing component includes a time relay, and the time relay is electrically connected to the control chip. When the foot step on the massage insole, the time relay starts to count to a certain period of time, and sends an electrical signal to the control chip, and the control chip controls the driving motor 3c1 to rotate to drive the massage bead chain 3a to rotate, and all the massage beads 3a1 move to the corresponding shallow groove 4b1 and the escape hole 4c1 of the second pad body 4c are be in contact with the sole of the foot. After the time relay starts to count for a certain period of time, the control chip controls the rotation of the driving motor 3c1 and the socket spring cooperates to bring all the massage beads 3a1 back to the corresponding deep groove 4b2. All the massage beads 3a1 are hidden under the second pad body 4c.

The thermostat component includes a temperature sensor, a battery, and an electric heating wire embedded in the main pad body 4a. The temperature sensor and the battery are electrically connected to the control chip, and the electric heating wire is electrically connected to the battery. A defined value for the control chip is set. When the temperature of the massage insole is less than the defined value, an electrical signal is transmitted to the control chip, the control chip controls the electric heating wire to heat the massage insole. The models of the temperature sensor, the time relay and the control chip are all existing technology, not detailed here.

The second pad body 4c includes a plurality of escape holes 4c1 for escaping all the massage beads 3a1, and all of the escape holes 4c1 correspond to all massage beads 3a1. The rotation of the driving motor 3c1 causes the massage bead chain 3a to rotate, and all the massage beads 3a1 move into the corresponding shallow groove 4b1 and the escape hole 4c1 of the second pad body 4c to interfere with the sole of the foot.

The working principle is as follows. When the foot step on the massage insole, the time relay starts to count to a certain period of time, and sends an electrical signal to the control chip, and the control chip controls the driving motor 3c1 to rotate to drive the massage bead chain 3a to rotate, and all the massage beads 3a1 move to the corresponding shallow groove 4b1 and the escape hole 4c1 of the second pad body 4c are be in contact with the sole of the foot. After the time relay starts to count for a certain period of time, the control chip controls the reversal rotation of the driving motor 3c1 and the socket spring cooperates to bring all the massage beads 3a1 back to the corresponding deep groove 4b2. All the massage beads 3a1 are hidden under the second pad body 4c.

The exemplary embodiments of the present invention are thus fully described. Although the description referred to particular embodiments, it will be clear to one skilled in the art that the present invention may be practiced with variations of these specific details. Hence this invention should not be construed as limited to the embodiments set forth herein.

What is claimed is:

1. A massage insole driven by intelligent sensing motor, comprising: a structurally symmetrical left insole 1 and right insole 2, wherein the left insole 1 and the right insole 2 each includes a massaging mechanism 3 for massaging the sole of the foot, and a receiving pad body 4 for receiving the massaging mechanism and a control mechanism; the control mechanism is arranged in the receiving pad body 4; the massaging mechanism 3 includes a massage bead chain 3a, a driving component 3c for driving the massage bead chain 3a to rotate, a reset component 3b for driving the massage bead chain 3a to be reset; two ends of massage bead chain 3a are respectively sleeved on the driving component 3c and the reset component 3b; the control mechanism includes a control chip, a timing component and a thermostatic component; the driving component 3c, the timing component and the thermostat component are electrically connected to the control chip,
wherein the receiving pad body 4 includes a main pad body 4a for receiving the massaging mechanism 3, a first pad body 4b for supporting the massage bead chain 3a, and a second pad body 4c disposed on the massage bead chain 3a; the main pad body 4a includes a receiving groove for receiving a massaging mechanism 3; the first pad body 4b is disposed in the receiving groove; the bottom of the first pad body 4b is provided with a toe hard plate 5 near the toe,
wherein the reset component 3b is disposed at an end of the first pad body 4b near the toe; the reset component 3b includes a reset socket spring 3b1, and the massage bead chain 3a is sleeved on the socket spring and fixedly connected with the socket spring; the socket spring is fixedly connected to the hard plate by a connecting column 3b2; the first pad body 4b is provided with a retreat groove 4b3 for avoiding the rotation of the socket spring,
wherein the driving component 3c includes a driving motor 3c1 and a driving wheel 3c2; the driving wheel 3c2 is fixedly mounted on an output end of the driving motor 3c1, and the driving motor 3c1 is disposed at an end of the first pad body 4b near the heel; the first pad body 4b is provided with a through hole through which the driving motor 3c1 passes; the drive wheel 3c2 is provided with a groove for the massage bead chain 3a to sleeve; the main pad body 4a is provided with a pad heel 4d for accommodating the driving motor 3c1 at a position close to the heel.

2. The massage insole driven by intelligent sensing motor of claim 1, wherein the massage bead chain 3a is provided with a connecting rope body 3a2 and a plurality of massage beads 3a1; all the massage beads 3a1 are equally spaced on the connecting rope body 3a2; the first pad body 4b is provided with a plurality of deep grooves 4b2 arranged in a matrix and a number of shallow grooves 4b1 distributed in a matrix; all deep grooves 4b2 and all shallow grooves 4b1 are arranged from the reset component 3b to the driving component 3c; all deep grooves 4b2 and all shallow grooves 4b1 are staggered one by one; all deep grooves 4b2 and all shallow grooves 4b1 correspond to all massage beads 3a1.

3. The massage insole driven by intelligent sensing motor of claim 1, wherein the timing component includes a time relay, and the time relay is electrically connected to the control chip.

4. The massage insole driven by intelligent sensing motor of claim 1, wherein the thermostat component includes a temperature sensor, a battery, and an electric heating wire embedded in the main pad body 4a; the temperature sensor and the battery are electrically connected to the control chip, and the electric heating wire is electrically connected to the battery.

5. The massage insole driven by intelligent sensing motor of claim 1, wherein the second pad body 4c includes a plurality of escape holes 4c1 for escaping all the massage beads 3a1, and all of the escape holes 4c1 correspond to all massage beads 3a1.
